(19) United States
(12) Patent Application Publication
(10) Pub. No.: US 2015/0068777 A1
(43) Pub. Date: Mar. 12, 2015

(54) ASYMMETRIC FIRE SUPRESSION SYSTEM

(71) Applicant: Lubrizol Advanced Materials, Inc., Wickliffe, OH (US)

(72) Inventors: Matthew R. Kuwatch, Green, OH (US); Jeffrey A. Gibson, West Olive, MI (US); Royce R. Klein, North Ridgeville, OH (US); Andrew Olah, Spencer, OH (US)

(73) Assignee: Lubrizol Advanced Materials, Inc., Cleveland, OH (US)

(21) Appl. No.: 14/388,258

(22) PCT Filed: Mar. 20, 2013
(86) PCT No.: PCT/US13/33088

§ 371 Date: Sep. 26, 2014

Related U.S. Application Data
(60) Provisional application No. 61/617,997, filed on Mar. 30, 2012.

(51) Int. Cl. A62C 37/11; A62C 35/60; A62C 35/64; A62C 3/00

(52) U.S. Cl. CPC A62C 37/11; A62C 3/00; A62C 35/60; A62C 35/64
USPC 169/60; 29/428

(57) ABSTRACT

A fire suppression system comprising multiple thermally activatable automatic sprinklers attached to multiple non-metallic conduits and wherein the pattern of the sprinklers is an asymmetric pattern. The fire suppression system is suitable for unfinished basements and other rooms having exposed joists. The asymmetric pattern is such that the distance between sprinklers installed in the direction of the joist run is at least one foot longer than the distance between sprinklers installed in the direction perpendicular to the joists. The most preferred non-metallic conduits are chlorinated polyvinyl chloride conduits.

### TECHNICAL FIELD

This invention relates generally to fire sprinkler systems. More specifically, exemplary embodiments relate to a fire sprinkler system using non-metallic pipes, such as CPVC, that may be installed in an area which has exposed joists, such as an unfinished basement. This invention involves placing the sprinklers in an asymmetric pattern.

### BACKGROUND

Fire sprinkler systems have become more popular in recent years as a way to save lives and property in a fire situation. Non-metallic pipes offer several advantages over competing materials for use in fire sprinkler systems, including cost benefits, non-corrosive, and ease of installation.

Currently, non-metallic pipes are used in fire sprinkler applications where a finished ceiling exists to enclose the non-metallic pipes, such as living areas on the first and second floors of homes. Fire sprinkler systems using non-metallic pipes are currently not approved for use in exposed composite or open web joist areas of a building.

One of the problems with using non-metallic pipes for fire sprinkler systems in areas having exposed composite or open web joists is in a normal 12 foot×12 foot spacing of the sprinklers, the water spray from the first sprinkler to activate, can deposit water on the adjacent sprinklers, thus cooling them to an extent that they do not activate.

It would be an advantage to have a sprinkler system using non-metallic pipes in an unfinished ceiling area, such as a basement, which has exposed joists.

### SUMMARY OF INVENTION

The above described problem is solved by an asymmetric spacing of the sprinklers. The exemplary sprinkler system, discussed in more detail herein, may be included in a basement or any other area having exposed joists.

The exposed joists may be solid wood joists, such as 2×10, 2×12 and the like, or may be composite wood joists, or open web floor truss joists. The most preferred joists are composite wood joists and solid wood joists. Of course, joists made from other materials, such as metal, may be used, but are less common in the building industry. The spacing of the joists from each other is usually 16 inches or 24 inches on center, but can be any spacing which is engineered to sustain the required load. The bottom of the joist is usually about 8 to about 10 feet in height from the floor of the building. The joists are substantially parallel to each other. The term “substantially parallel” is intended to take account of the normal tolerances of the building trades and is usually within about 0.5 inch in width in a 24 ft. length of the joist from being exactly parallel. The building structure will have multiple spaced apart joists.

The non-metallic pipes referred to in this invention are intended to include any non-solid metal pipes. Solid metal pipes, such as copper, steel, iron, aluminum, and the like are excluded from this invention. Suitable non-metallic pipes include, but are not limited to, thermoplastic and thermoset polymer pipes, such as polyethylene, crosslinked polyethylene (PEX), polypropylene, and chlorinated polyvinyl chloride (CPVC). The polymer pipe material can be composite materials, such as the polymer reinforced with other fibrous materials. For example, PEX or polypropylene can be reinforced with fiberglass or aluminum. Since chlorinated polyvinyl chloride (CPVC) is the most preferred non-metallic material for use in fire sprinkler piping, the invention will be described in detail below using CPVC. CPVC has been found to be useful without the need of further reinforcement using fiber fillers. Since CPVC is the preferred non-metallic pipe, this invention will be described below using CPVC pipe and fittings. It should be understood that other non-metallic systems can be used and would require different fittings, as is well understood in the art. The common factor would be the asymmetrical spacing of the sprinklers.

The fire suppression system of this invention has multiple chlorinated polyvinyl chloride (CPVC) sprinkler conduits (pipes). In an exemplary embodiment, the system has a first conduit extending within the space defined by a first set of two adjacent substantially parallel joists. The first conduit extends substantially parallel to the first set of joists. The system also has a second CPVC sprinkler conduit extending within the space defined by a second set of two adjacent substantially parallel joists. The second CPVC conduit extends substantially parallel to the second set of joists. There can be third, fourth, fifth, etc., CPVC sprinkler conduits necessary to cover the area of the room where fire protection is desired. The CPVC conduits will normally contain a fire suppression fluid under pressure, usually as low as 7 psig up to about 175 psig. Psig refers to a pressure measurement in pounds per square inch above normal atmospheric pressure (normally stipulated as 1 atmosphere). The fire suppression fluid is most preferably water, but can be any non-flammable fluid or gas capable of extinguishing a fire. The CPVC conduits can vary in diameter, depending on the amount of fluid needed and the pressure available, from 0.75 inch to 4 inches, but for most applications 0.75 to 1.25 inches is preferred, with 1.0 inch being the most preferred diameter. The diameter specified is an iron pipe size (IPS) diameter.

In the exemplary embodiment, there are multiple thermally activatable automatic sprinklers attached to the first CPVC conduit. The thermally activatable automatic sprinklers are in fluid connection with the first CPVC conduit and are attached in a generally perpendicular relationship to the first CPVC conduit. The term “generally perpendicular”, as used herein, means that the sprinkler is no more than 1 inch off perpendicular per 1 foot in length, and preferably no more than 0.25 inch off perpendicular per 1 foot in length. The thermally activatable automatic sprinkler is attached to the CPVC conduit by the use of a short length of CPVC pipe (drop) of a diameter which is usually equal to or smaller than the CPVC sprinkler conduit. For example, if a 1.0 inch CPVC conduit is used, the short length of the drop CPVC pipe could be 0.75 inch in diameter. One end of the drop CPVC pipe is attached to the CPVC conduit by the use of a CPVC fitting, such as a “T” fitting. The other end of the drop CPVC pipe is attached to the sprinkler, usually by the use of a threaded fitting. The length of the drop CPVC pipe is sufficient to cause the lower most part of the sprinkler (deflection plate) to be about 1.5 inches below the bottom edge of the joist. Normally, the length of the drop CPVC pipe will be from about 1 to about 12 inches.

Each of the multiple thermally activatable automatic sprinklers is substantially equally spaced a first predetermined distance from adjacent sprinklers on the first sprinkler conduit. The first predetermined distance can be from 13 feet to 18 feet.

The multiple thermally activatable automatic sprinklers are selected to activate at a given temperature to release the fire suppression fluid. The activation temperature is usually from about 140° to about 190° F., more preferably from about 155° F. to about 175° F.

Multiple thermally activatable automatic sprinklers are also attached to the second CPVC conduit, at a second predetermined distance from adjacent sprinklers, in a similar fashion as described above for the first CPVC conduit. If a third, fourth, fifth, etc. conduits are used, the multiple thermally activatable automatic sprinklers would be attached at a predetermined distance from adjacent sprinklers on the same conduit. The first and second predetermined distances are substantially equal.

The first and second predetermined distance is at least one foot in length and up to 6 feet in length greater than the distance between the thermally activatable automatic sprinklers attached to the first CPVC conduit and the nearest thermally activatable automatic sprinkler attached to the second CPVC conduit. For example, this would result in a rectangular sprinkler spacing, such as 12 feet wide and 13, 14, 15, 16, 17, or 18 feet long. A spacing of 12 feet wide and either 14 or 16 feet long has been found to be preferred. Normal prior art sprinkler spacing is a square spacing, such as 12 feet wide by 12 feet long. The sprinkler spacing in this invention is asymmetric.

### BRIEF DESCRIPTION OF DRAWINGS

FIG. 1 is a perspective view of a fire suppression system having multiple solid wood joists, multiple CPVC sprinkler conduits and multiple thermally activatable automatic sprinklers in fluid communication with the CPVC conduits.

FIG. 2 is an end view of a fire suppression system using composite wood joists, multiple CPVC sprinkler conduits and multiple thermally activatable automatic sprinklers in fluid communication with the CPVC conduits.

FIG. 3 is a top plan view of the spacing for the multiple thermally activatable automatic sprinklers for the fire test to evaluate sprinkler activation times used in the Examples.

### DETAILED DESCRIPTION

The foregoing summary, as well as the following detailed description of exemplary embodiments, will be better understood when read in conjunction with the appended drawings. For the purpose of illustrating the exemplary embodiments, there is shown in the drawings certain exemplary systems. It should be understood, however, that these embodiments are merely exemplary and that the present invention is not limited to systems, arrangements and instrumentalities shown or described herein.

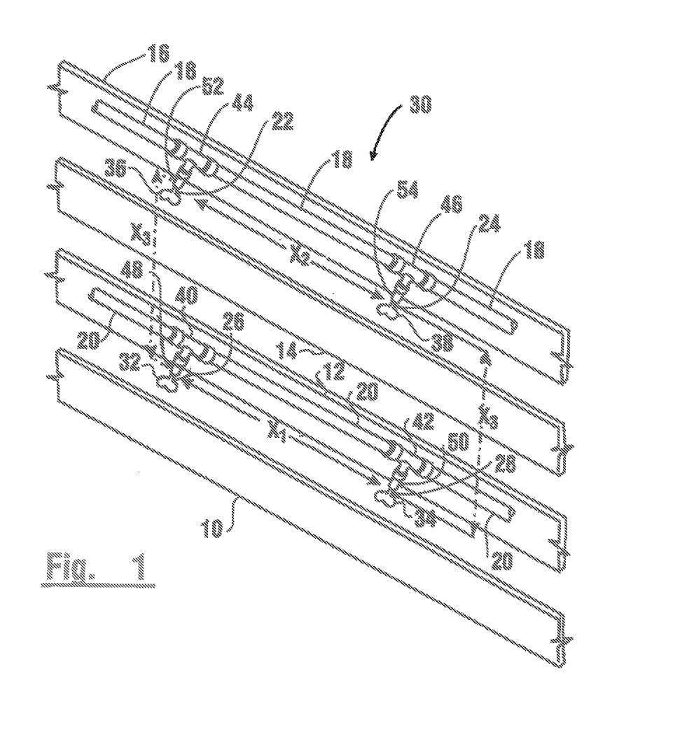

In FIG. 1, there is shown an exemplary embodiment for a fire suppression system 30 (not drawn to scale) having asymmetric spacing of the sprinklers. The system is shown with multiple spaced apart solid wood joists, which are normally 2×10, or 2×12, for residential construction. The solid wood joists are shown as reference numerals 10, 12, 14, and 16. Of course, the number of joists, their dimension and spacing will depend on the size of the building and the load it is required to support. The joists are substantially parallel to each other. Since the joists are normally installed by carpenters, they can vary slightly from being perfectly parallel. The term “substantially parallel” is intended to take account of the normal tolerances of the building trades and is usually within about 0.5 inch in width in a 24 feet length of the joist from being exactly parallel.

The fire suppression system 30 has a first chlorinated polyvinyl chloride (CPVC) conduit 20 (also referred to as a pipe) extending within the space defined by a first set of two adjacent substantially parallel joists 10 and 12. It is intended that the phrase “space defined by a first set of two substantially parallel joists” means the space between the joists extending from the top of the joists to the bottom of the joists. Since a sub-floor will be attached to the top of the joists, the space will be closed on three sides and open on the bottom side.

The CPVC conduit 20 will normally contain a fire suppression fluid under pressure, usually from about 7 to about 175 psig, preferably from about 30 to about 175 psig, and more preferably from about 80 to about 175 psig, with the most preferred pressure being from 100 to 150 psig. Thermally activatable automatic sprinklers are designed with specific optimal operating pressures. Activatable sprinklers may not give adequate water spray to satisfactorily extinguish a fire at pressures below about 7 psig, therefore the pressure of the fluid in the conduits should be well above this minimum pressure to assure optimal extinguishing effect. The fire suppression fluid is, most preferably, water but can be any non-flammable fluid or gas capable of extinguishing a fire. The CPVC conduit 20 can vary in diameter, depending on the amount of fluid needed and the pressure available, from 0.75 inch to 4 inches, but for most applications 0.75 inch to 1.25 inches is preferred, with 1.0 inch being the most preferred diameter. The diameter specified in this invention is an iron pipe size (IPS) diameter. The CPVC sprinkler conduit 20 may be in multiple lengths where the individual lengths of the conduit are attached by the use of CPVC fittings. When the term first CPVC conduit is used, it is intended to include all the separate pieces of the conduit that are joined in fluid communication by the use of a CPVC fitting.

In the embodiment shown in FIG. 1, fire suppression system 30 has multiple thermally activatable automatic sprinklers 26 and 28 attached to the first CPVC conduit 20. The thermally activatable automatic sprinklers are in fluid connection with the first CPVC conduit and are attached in a generally perpendicular relationship to the first CPVC conduit 20. The term “generally perpendicular”, as used herein, means that the sprinkler is no more than 1 inch off perpendicular per foot in length, as measured from the centerline of conduit 20 to the bottom surface of the deflection plates 32 and 34. The thermally activatable automated sprinklers 26 and 28 are attached to the conduit 20 by the use of CPVC fittings 40 and 42. An example of a suitable fitting is a “T” fitting, as shown in FIG. 1 as 40 and 42. The “T” fitting has two openings 180° apart configured to receive two sections of conduit 20 and a third opening 90° from the two openings. The third opening is configured to receive a drop length of CPVC pipe 48 and 50. The sprinklers 26 and 28 are attached to the drop length of CPVC pipes 48 and 50 respectively. The bottom ends of the drop length CPVC pipes 48 and 50 can have a threaded fitting which allows the sprinklers 26 and 28 to be screwed into pipes 48 and 50. The length of the drop length of CPVC pipes 48 and 50 is sufficient to cause the lower most part of the sprinklers, which is the deflection plates 32 and 34, to be about 1.5 inches below the bottom edge of joist 12. Normally, the length of the drop length of CPVC pipe will be from about 1.0 to about 12 inches. This distance can vary depending on the height of the joists and the placement of conduit 20 within the space defined by adjacent parallel joists 10 and 12. The short drop lengths of CPVC pipe 48 and 50 are normally equal to or slightly smaller in diameter than the conduit 20. For example, for a 1.0 inch diameter conduit, a 0.75 inch diameter can be used for the drop length CPVC pipes.

Each of the multiple thermally activatable automatic sprinklers, attached to the first CPVC conduit 20, are substantially equally spaced a first predetermined distance X₁, from adjacent sprinklers on conduit 20. The first predetermined distance can be from 13 feet to 18 feet. The term “substantially equally spaced” is intended to account for normal variations in installing the system and can be ±1.0 inch in length.

In the embodiment shown in FIG. 1, there is shown a second CPVC conduit 18 within the space between joists 14 and 16. There are multiple thermally activatable automatic sprinklers 22 and 24 attached to the second CPVC conduit 18. The sprinklers 22 and 24 are attached at a second predetermined distance X₂ from adjacent sprinklers attached to the second CPVC conduit 18. The sprinklers 22 and 24 are attached in a generally perpendicular relationship to the second CPVC conduit 18, using the same procedure as described above for attaching sprinklers 26 and 28 to the first CPVC conduit 20. That is, CPVC “T” fittings 44 and 46 are used together with drop length CPVC pipes 52 and 54, to provide a fluid connection between conduit 18 and sprinklers 22 and 24. Each sprinkler has a deflection plate 36 and 38 as in sprinklers 26 and 28 described above. The second CPVC conduit 18 may be in multiple lengths joined together in fluid communication by CPVC fittings, as is described above for the first CPVC conduit 20.

The first predetermined distance X₁ for the sprinkler spacing on conduit 20 is substantially equal to the second predetermined distance X₂ for the sprinkler spacing on conduit 18. The term “substantially equal” is intended to be within ±1 inch.

FIG. 1 shows only two sprinklers attached to each of CPVC conduits 18 and 20. The number of sprinklers attached to each conduit can vary in number depending on the length of the joists, which relates to the size of the area protected by the fire suppression system. Likewise, only four joists are shown in FIG. 1. The number of joists will depend on the size of the building supported by the joists.

The multiple thermally activatable sprinklers are selected to activate at a given temperature to release the fire suppression fluid. The activation temperature is usually from about 140° F. to about 190° F., more preferably from about 155° F. to about 175° F. The sprinklers are commercially available from multiple suppliers. A particularly desirable sprinkler is sold by Tyco, as its Series LF II residential pendent sprinklers 3.0 K-factor. The K-factor determines the fluid flow out of the activated sprinkler. The fire suppression fluid flow is the K-factor multiplied by the square root of the supply pressure. For example, a 3.0 K-factor with a 100 psig pressure in the CPVC conduits would give a 30 gallons per minute of fluid flow.

The first and second predetermined distance X₁ and X₂ is at least one foot in length and up to 6 feet in length greater than the distance X₃ between the thermally activatable automatic sprinklers attached to the first CPVC conduit 20 and the nearest thermally activatable automatic sprinkler attached to the second CPVC conduit 18. In the embodiment shown in FIG. 1, the sprinkler 26 is a distance X₃ from sprinkler 22, and sprinkler 28 is a distance X₃ from sprinkler 24. X₁ and X₂ are at least 1 foot greater, and preferably 2 feet greater than X₃. For example, this would result in a rectangular sprinkler spacing, such as X₃ being 12 feet and X₁ and X₂ being 13, 14, 15, 16, 17, or 18 feet long. A spacing of 12 or 14 feet for X₃ and either 14 or 16 feet for X₁ and X₂ has been found to be preferred, provided that X₁ and X₂ are at least 1 foot greater than X₃. Normal prior art sprinkler spacing is a square spacing, such as 12 feet by 12 feet. The sprinkler spacing in this invention is asymmetric.

The asymmetric spacing solves the problem presented when one sprinkler activates and sprays water onto the thermal activating unit of the adjacent sprinkler, and causes a delay in the adjacent sprinkler activating. This phenomenon is called “cold soldering” of the adjacent sprinkler, and this situation can allow the fire to spread beyond where it would if the adjacent sprinkler activated in a timely manner. The “cold soldering” event is more likely to occur with a high supply pressure, such as 175 psig. At least one sprinkler should activate and release the fire suppression fluid within 3 minutes, and preferably within 2 minutes, under a test protocol by Underwriters Laboratory known as UL Project Number 10CA23869. In the most preferred embodiment, all sprinklers activate within 3 minutes, provided they reach the activation temperature.

The fire test specified by UL Project Number 10CA23869 results in a very intense fire. A 5 square foot pan is placed on the floor of the room and water placed in the pan. Five gallons of heptane is floated on the water and ignited. As the heptane is burning, some of the heptane vaporizes and the vapor also catches fire, resulting in a very intense fire. Because the joists are open, as in an unfinished basement, the most intense heat tends to travel down the length of the joists in the space between adjacent joists.

The fire suppression system described in this invention is intended for use in areas having unfinished ceiling with exposed joists, such as unfinished basements and the like.

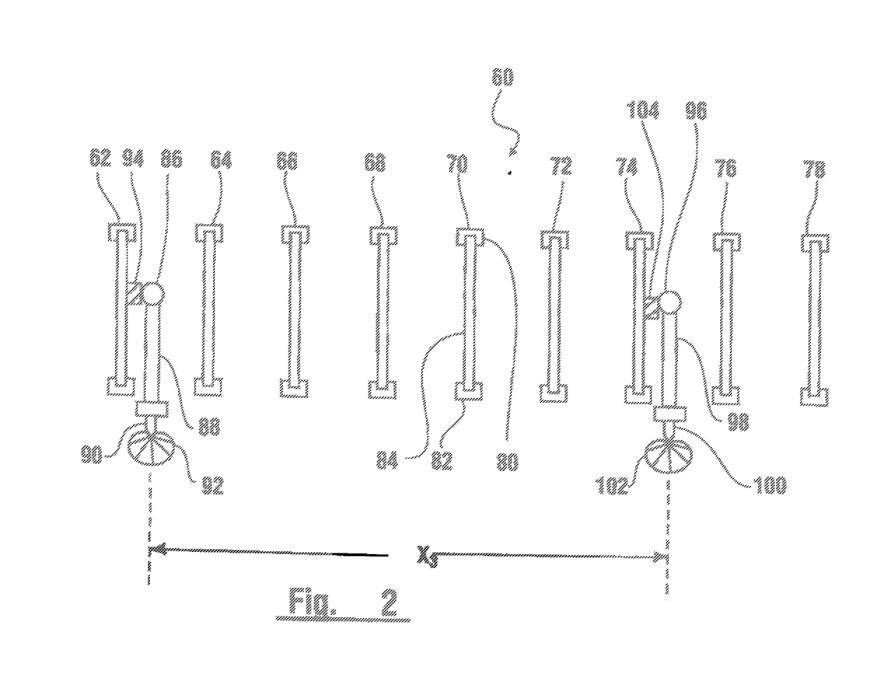

FIG. 1 described the system with solid wood joists, such as 2×10, 2×12, and the like. Other types of joists are also applicable, such as composite joists (see FIG. 2) and open web joists which are also referred to as floor trusses. The fire suppression system is applicable to enclosures having various ceiling heights (distance from the floor to the bottom of the joists). Common ceiling heights are from about 7 to about 12 feet, preferably from 8 to 10 feet, but can be more or less than this common height.

Another embodiment is shown in FIG. 2. FIG. 2 is an end view of a fire suppression system 60 where the joists are wood composite joists. Nine joists (62, 64, 66, 68, 70, 72, 74, 76 and 78) are shown in FIG. 2. The joists are all identical, so for brevity only joist 70 will be described. Joist 70 has a top flange 80, a bottom flange 82, and a web 84 connecting the top flange 80 to the bottom flange 82. The top flange 80 and bottom flange 82 are each usually from 1.75 inches to 3.5 inches wide. The web 84 is usually from about 0.375 inch to about 0.45 inch in thickness and from 9.5 to 16 inches high. The size of the flanges and web will vary depending on the required load the composite truss must support, as is well understood in the construction industry.

In the embodiment shown in FIG. 2, a first CPVC sprinkler conduit 86 extends within the space defined by a first set of two adjacent substantially parallel joists 62 and 64. The conduit 86 is generally parallel to joists 62 and 64. In fluid connection with conduit 86, is a short drop length of CPVC pipe 88. A thermally activatable automatic sprinkler 90 is in fluid connection with the drop length of CPVC pipe 88. The connections can be made in the same way as described in FIG. 1 above. The sprinkler 90 has a deflection plate 92 at the lower end of sprinkler 90. A block of wood 94, such as a 2×4, can be used to give a space between joist 62 and conduit 86. The spacing block 94 is optional, as the spacing between joist 62 and conduit 86 can be established by the use of a hanger (not shown). It should be understood that there will be multiple thermally activatable automatic sprinklers (not shown) attached to the CPVC conduit 86. The multiple thermally activatable automatic sprinklers will be spaced a first predetermined distance from adjacent sprinklers on conduit 86. The first predetermined distance is as described in FIG. 1 above and is from about 13 to 18 feet.

In FIG. 2, there is shown a second CPVC conduit 96 within the space defined by a second set of two adjacent substantially parallel joists 74 and 76. The conduit 96 is generally parallel to joists 74 and 76. In fluid connection with conduit 96 is a short drop length of CPVC pipe 98. A thermally activatable automatic sprinkler 100 is in fluid connection with the short length of CPVC pipe 98. The connections can be made as is described in FIG. 1 above. There is a deflection plate 102, at the lower end of sprinkler 100, which will result in the fire suppression fluid being sprayed in a 360° pattern upon activation of sprinkler 100. A block of wood 104, such as a 2×4, or a hanger (not shown) can be used to give a space between conduit 96 and joist 74. There will be multiple thermally activatable automatic sprinklers (not shown) attached to CPVC conduit 96 and spaced a second predetermined distance from adjacent sprinklers on conduit 96. The first and second predetermined distances are substantially equal and can be from 13 to 18 feet.

The spacing of the sprinklers on conduit 86 is a distance X₃ from adjacent sprinklers on conduit 96. The distance X₃ is from 12 feet to 14 feet, with the proviso that X₃ must be at least 1 foot shorter than the first and second predetermined distance for the spacing of the multiple thermally activatable automatic sprinklers on conduits 86 and 96. This spacing gives an asymmetrical spacing of the sprinklers. The distance X₃ is from 12 feet to 14 feet. If X₃ is 12 feet then the sprinkler spacing on conduits 86 and 96 (first and second predetermined distances) is from 13 to 18 feet. If X₃ is 14 feet, then the sprinkler spacing on conduits 86 and 96 is from 15 to 18 feet. A spacing pattern of 12×14 feet, 12×16 feet, and 14×16 feet have been found to be ideal for extinguishing fire and preventing water spray onto adjacent sprinklers, which can cause “cold soldering.”

Another advantage of the asymmetric spacing configuration is less sprinklers are required to protect a given area. The prior art square spacing of 12×12 feet covers 144 square feet of floor area per sprinkler, whereas an asymmetric spacing of 12×14 feet covers 168 square feet of floor area per sprinkler, or about 16% fewer sprinklers would be required for the asymmetric spacing versus the prior art square spacing. A reduction in the number of sprinklers saves material cost and installation time.

The joists, shown in FIG. 1 and FIG. 2, would have a sub-floor (not shown) attached to the top of the joists. The sub-floor would normally be plywood or composite board.

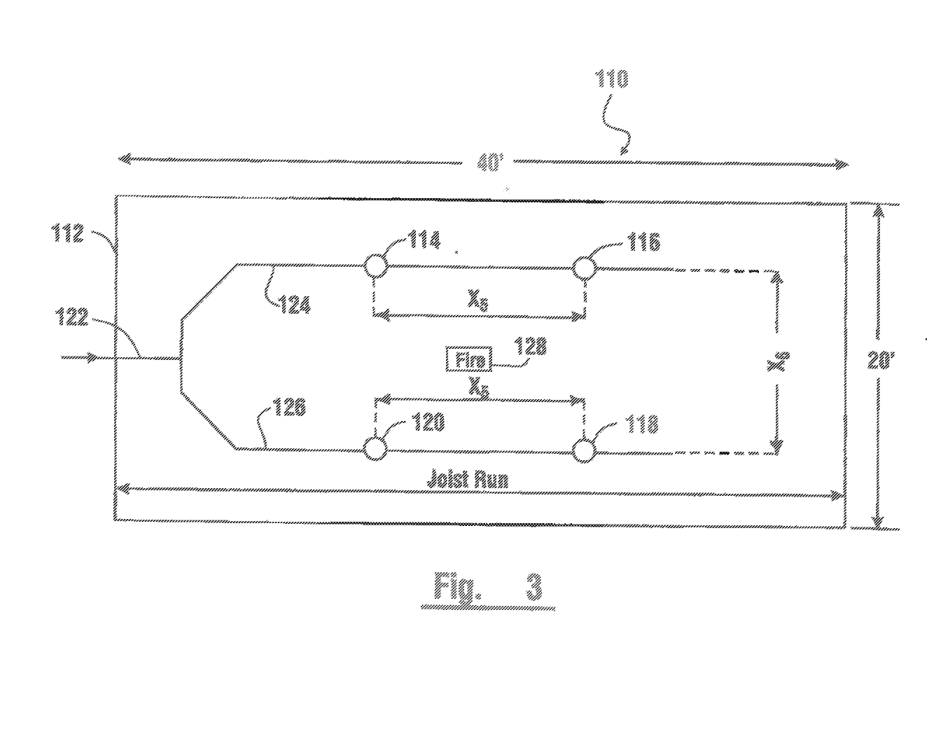

FIG. 3 is a top plan view of a sprinkler configuration 110 used for the sprinkler response time test in the Examples shown below. The system is placed in a 20 feet×40 feet building 112. There are 4 sprinklers 114, 116, 118, and 120. Pressurized fire suppression water is fed to the system through a main supply line 122. The main supply line 122, feeds the fire suppression water to CPVC conduits 124 and 126. The CPVC conduits 124 and 126 are placed within the space defined by adjacent joists (not shown) and substantially parallel to said joists. The joists run parallel to the long side (40 ft side) of the building. A five square foot fire source container 128 is placed on the floor at the center of the 4 sprinklers. The fire source is 5 gallons of heptane floating on water. The heptane is ignited and the time until each of the sprinklers is activated is recorded. To pass the test, the first sprinkler should activate in 3 minutes or less, and preferably in 2 minutes or less. The distance between sprinklers on the same conduit, such as 114 to 116 and 120 to 118 are shown as distance X₅. The distance between sprinklers on different adjacent conduits, such as 116 to 118, is shown as distance X₆. The sprinkler spacing can be changed to evaluate different spacing on a given conduit (X₅) and between conduits (X₆).

In the exemplary embodiment, the CPVC material used for the conduits, short drop length CPVC pipe, and CPVC fittings is sold under the BLAZEMASTER® brand name and the CPVC compound to make the CPVC articles is available from Lubrizol Advanced Materials, Inc. in Brecksville, Ohio, U.S.A.

The fire suppression system of this invention can be installed as a branch system or a loop system. The terms branch system and loop system are well understood by those skilled in plumbing systems. With a branch system there is usually a main supply line and branch pipes connected to the main line and the sprinklers are attached to the branch line. In a loop system, the conduits supplying the fire suppression fluid form a closed loop. The loop system is preferred for non-metallic piping systems because when a sprinkler activates water flows in both directions to the sprinkler, which helps to cool the conduits, non-metallic conduits can rupture and fail if they get too hot. The embodiments shown in this description for basements could be extended to connect with the sprinkler conduits on upper floors of the building, as is well understood by those skilled in the art of installing sprinkler systems.

The invention will be better understood by referring to the Examples, which show an unexpected improvement when an asymmetric sprinkler spacing is employed.

### EXAMPLES

Examples 1 to 4 are presented to show the improvement when using an asymmetric spacing for the sprinklers. All tests were run in a 20 feet by 40 feet fire test building. A floor joist structure was constructed with dimensions 20 feet by 32 feet, with 32 feet long composite wood joists, each being 11.875 inches high. The distance from the bottom of the joists to the floor was 10 feet. The joists were spaced 24 inches on center. The fire test was conducted to simulate the UL10CA23869 test procedure and determine sprinkler activation time. The sprinkler conduits used were both 1 inch diameter BLAZEMASTER® CPVC pipes. The thermally activatable sprinklers were all Tyco Model LF II Residential Pendent sprinklers with a 3.0 K-factor and a temperature activation rating of 155° F. The fire suppression fluid was water and at a pressure of 100 psig. The fire fuel was 5 gallons of heptane. The time to activation after the fire started for each of the sprinklers were measured and recorded. The test was repeated with different sprinkler spacing. The results are shown in Table I below.

TABLE I

| | Sprinkler Spacing (FIG. 3) | | Activation Time (min:sec) | | | |
|---|---|---|---|---|---|---|
| | Wide (X₆) | Deep (X₅) | Sprinkler No. (from FIG. 3) | | | |
| Example | Feet | Feet | 114 | 116 | 118 | 120 |
| 1* | 12^{′} | 12^{′} | 1:45 | 2:33 | ** | 1:07 |
| 2 | 12^{′} | 14^{′} | 1:03 | 0:50 | 2:03 | 2:00 |
| 3 | 12^{′} | 16^{′} | 0:57 | 0:51 | 1:05 | 1:07 |
| 4 | 14^{′} | 16^{′} | 2:14 | 1:10 | 1:43 | 1:05 |

*Comparative test using prior art spacing of 12 ft. × 12 ft.
** Sprinkler did not activate.

The results show that the symmetrical spacing (12′×12′) of the sprinklers, in Example 1, resulted in one of the sprinklers (118) not activating. It is believed this was due to cold soldering, where the first sprinkler to activate (120) sprayed cold water onto sprinkler 118 and kept it too cool to activate. In Examples 2, 3, and 4, with an asymmetrical spacing for the sprinklers, all sprinklers activated in a timely manner.

Examples 1 and 2 were repeated with a supply pressure of 175 psig. In Example 1, with the higher pressure sprinklers 118 and 120, both failed to activate and sprinklers 114 and 116 activated at 53 and 36 seconds respectively. At the higher pressure (175 psig) in Example 2, all four sprinklers activated at times ranging from 54 seconds for sprinkler 116 to 2:15 for sprinkler 120. This demonstrates that the “cold soldering” effect is more of a problem with higher water pressure and symmetrical spacing (12 ft.×12 ft.) of Example 1. With the asymmetrical spacing (12 ft.×14 ft.) of this invention, all sprinklers activated even with higher pressure.

In the foregoing description, certain terms have been used for brevity, clarity and understanding. However, no unnecessary limitations are to be implied therefrom because such terms are used for descriptive purposes and are not intended to be broadly construed. Moreover, the descriptions herein are by way of examples, and the invention is not limited to the details shown and described.

Having described the features, discoveries and principles of the invention, the manner in which it is made, and the advantages and useful results attained, the new and useful invention are set forth in the appended claims.

1. A fire suppression system for exposed basement ceilings or other structures having multiple spaced apart exposed ceiling joists comprising:
(a) a first non-metallic sprinkler conduit extending within the space defined by a first set of two adjacent substantially parallel joists and generally parallel to said first set of parallel joists;
(b) a second non-metallic sprinkler conduit extending within the space defined by a second set of two adjacent substantially parallel joists and generally parallel to said second set of parallel joists;
(c) multiple thermally activatable automatic sprinklers, attached in a generally perpendicular relationship to said first non-metallic conduit and in fluid connection with said first conduit and substantially equally spaced a first predetermined distance from adjacent thermally activatable automatic sprinklers on said first non-metallic sprinkler conduit;
(d) multiple thermally activatable automatic sprinklers attached in a generally perpendicular relationship to said second non-metallic conduit, and in fluid connection with said second conduit, and substantially equally spaced a second predetermined distance from adjacent thermally activatable automatic sprinklers on said second non-metallic sprinkler conduit;
wherein, said first predetermined distance and said second predetermined distance are substantially equal;
wherein, said first and said second predetermined distance is at least one foot in length greater than the distance between said thermally activatable automatic sprinklers attached to said first non-metallic conduit and the nearest thermally activatable automatic sprinklers attached to said second non-metallic conduit;
wherein, said fire suppression system is pressurized with a fire suppression fluid; and
wherein, the bottom of said exposed joists is from 7 to 12 feet in height from the floor.

2. The fire suppression system of claim 1, wherein said first and said second non-metallic sprinkler conduits are chlorinated polyvinyl chloride conduits.

3. The fire suppression system of claim 2, wherein said first and said second predetermined distance is about two feet to about six feet in length greater than the distance between said thermally activatable automatic sprinklers attached to said first chlorinated polyvinyl chloride conduit and the nearest thermally activatable automatic sprinklers attached to said second chlorinated polyvinyl chloride conduit.

4. The fire suppression system of claim 2, wherein said first and said second predetermined distance is from about 13 feet to about 18 feet in length.

5. The fire suppression system of claim 4, wherein said first and said second predetermined distance is from about 14 feet to about 16 feet in length.

6. The fire suppression system of claim 2, wherein the distance between said thermally activatable automatic sprinklers attached to said first chlorinated polyvinyl chloride conduit and the nearest thermally activatable automatic sprinklers attached to said second chlorinated polyvinyl chloride conduit, is from about 12 feet to about 14 feet.

7. The fire suppression system of claim 2, wherein the bottom of the exposed joists is from about 8 to about 10 feet in height from the floor.

8. The fire suppression system of claim 1, wherein at least one thermally activatable automatic sprinklers is activated in less than 3 minutes upon exposure to a fire, according to UL Project Number 10CA23869 test.

9. The fire suppression system of claim 8, wherein at least one thermally activatable automatic sprinklers is activated in less than 2 minutes upon exposure to a fire according to UL Project Number 10CA23869 test.

10. The fire suppression system of claim 1, wherein said joists are made from wood.

11. The fire suppression system of claim 10, wherein said joists are selected from the group consisting of solid wood joists, open web floor truss joists, and composite wood joists.

12. The fire suppression system of claim 1, wherein said fire suppression fluid is pressurized to a pressure of from about 7 psig to about 175 psig.

13. The fire suppression system of claim 12, wherein said fire suppression fluid is pressurized to a pressure of from about 50 psig to about 150 psig.

14. The fire suppression system of claim 2, wherein said chlorinated polyvinyl chloride conduits are from 0.75 inch to 4.0 inches diameter IPS size conduits.

15. The fire suppression system of claim 2, wherein said thermally activatable automatic sprinklers are connected to said chlorinated polyvinyl conduit by a 0.75 inch to 1.25 inches diameter IPS size chlorinated polyvinyl chloride pipe.

16. The fire suppression system of claim 1, wherein said conduits are a loop system.

17. The fire suppression system of claim 1, wherein said conduits are a branched system.

18. A fire suppression system for exposed basement ceilings having multiple thermally activatable sprinklers installed in an asymmetric pattern.

19. A method of installing a CPVC fire sprinkler system in an area of a building having exposed ceiling joists comprising:
(a) installing multiple CPVC sprinkler conduits, and
(b) attaching multiple thermally activatable automatic sprinklers to each of said CPVC sprinkler conduits;
wherein said sprinklers are attached in an asymmetrical spacing pattern with the distance between sprinklers in the direction of the joist run being at least one foot longer than the distance from the nearest sprinkler on an adjoining conduit.

20. The method of claim 19, wherein the distance between sprinklers in the direction of the joist run are at least two feet longer than the distance from the nearest sprinkler on an adjoining conduit.

21. The method of claim 20, wherein the spacing pattern of said sprinklers is 12 feet by 14 feet.

22. The method of claim 20, wherein the spacing pattern of said sprinklers is 14 feet by 16 feet.
